(19) United States
(12) Patent Application Publication
(10) Pub. No.: US 2024/0185333 A1
(43) Pub. Date: Jun. 6, 2024

(54) DIGITAL FINANCIAL MANAGEMENT HAVING MONITORING AND ALERTS OF ACTIVITY OF USER-DESIGNATED BENEFICARY ACCOUNT

(71) Applicant: Truist Bank, Charlotte, NC (US)

(72) Inventors: Kobe Ampomah, Henrico, VA (US); Surendra Puduru, Raleigh, NC (US)

(21) Appl. No.: 18/062,089

(22) Filed: Dec. 6, 2022

(51) Int. Cl. G06Q 40/02

(52) U.S. Cl. CPC G06Q 40/02

(57) ABSTRACT

A computing device, a computer program product, and a computer-implemented method for delivering financial services and, more particularly, for facilitating enhanced network communication between a user and a financial institution. A user having one or more financial accounts at the financial institution is given a digital platform which facilitates the monitoring of financial transactions by a legal minor/dependent who is designated as a secondary account holder while promoting financial literacy and establishing credit by the legal minor/dependent.

### TECHNICAL FIELD

The present disclosure relates to a computing device, computer program product, and computer-implemented method for delivering digital financial services and, more particularly, for facilitating the monitoring of financial transactions by a legal minor/dependent who is designated as a secondary account holder while promoting financial literacy and establishing credit by the legal minor/dependent.

### BACKGROUND

Financial institutions that provide financial services are increasingly providing a greater number of client services. Such financial institutions offer services that include one or more financial accounts that provide financial security for a financial account holder. The financial account holder may also maintain one or more sub/secondary financial accounts for the benefit of a legal minor/dependent, such as, for example, a child/dependent of the primary financial account holder.

Such financial account holders who are parents desire to have a digital platform that promotes financial literacy to the legal minor/dependent through responsible spending.

### SUMMARY

The present disclosure relates to a computing device, a computer program product, and a computer-implemented method for delivering enhanced digital financial services over a communication network while promoting financial literacy in a manner that also establishes financial credit in the name of a legal minor/dependent.

In accordance with one or more embodiments set forth, illustrated, and described herein, a computing device, a computer program product, and a computer-implemented method is provided for a digital platform which facilitates dynamic monitoring of transactions by a legal minor/dependent via a debit card or a mobile wallet associated with one or more user-designated beneficiary financial accounts that are sub/secondary accounts to a primary financial account maintained at a financial institution. The types of user-designated beneficiary financial accounts include, but is not limited to, any user account associated with a personal account, a commercial account, and a wealth management account. Example accounts may include, but is not limited to, checking accounts, savings accounts, credit accounts, money market accounts (MMA), certificates of deposit (CD), lines-of-credit, etc.

In accordance with one or more embodiments set forth, illustrated, and described herein, the financial account holder, maintaining one or more primary financial accounts at the financial institution, may establish one or more user-designated beneficiary financial accounts that are associated with the one or more primary financial accounts via a mobile application associated with the financial institution (“financial institution mobile application”). The one or more user-designated beneficiary financial accounts may be for the benefit of a legal minor/dependent, such as, for example, a child/dependent of a financial account holder. The one or more user-designated beneficiary accounts may comprise subaccounts at the financial institution to which one or more legal minor/dependents is designated beneficiary. Each one of the subaccounts may be a savings account. The savings account could comprise an account held in trust for the benefit of the child/dependent. One or more debit cards and mobile wallets may be associated with the savings account. The one or more debit cards and mobile wallets facilitate the promotion of financial literacy to the child/dependent through responsible spending, while also establishing financial credit to the benefit of the child/dependent.

In accordance with one or more embodiments set forth, illustrated, and described herein, the financial account holder may, via the financial institution mobile application executing on the client device, set a minimum financial transaction threshold and a maximum financial transaction threshold on the debit cards and mobile wallets. The minimum financial transaction threshold and the maximum financial transaction threshold may be associated with a temporal threshold, e.g., daily, weekly, monthly, annually, etc. The financial transaction can be associated with an actual purchase of goods of services, or a withdrawal of funds from a user-designated beneficiary account.

In accordance with one or more embodiments set forth, illustrated, and described herein, the financial account holder may, via the financial institution mobile application executing on the client device, control access to data and information associated with the one or more primary financial accounts and the one or more user-designated beneficiary financial accounts. In this way, the child/dependent, via the financial institution mobile application executing on a second client device used by the child/dependent, may be restricted from accessing all data and information associated with the one or more primary financial accounts. Although the financial account holder may grant the child/dependent access as an administrator, this access level will be generally restricted by default. The child/dependent may be granted access, however, as a viewer to only view data and information associated with the one or more user-designated beneficiary financial accounts.

In accordance with one or more embodiments set forth, illustrated, and described herein, via the financial institution mobile application executing on the client device, the financial account holder is given a digital platform to dynamically monitor financial transactions from the debit cards and mobile wallets associated with the one or more user-designated beneficiary financial accounts.

In accordance with one or more embodiments set forth, illustrated, and described herein, the financial account holder may, via the financial institution mobile application executing on the client device, dynamically receive one or more visual alerts and/or electronic notifications (e.g., email, text, pop-up, etc.) when a financial transaction is made using the debit card or the mobile wallet. The electronic notifications may include a user-engageable link that when engaged by the financial account holder facilitates viewing of the transaction history (e.g., transaction date, transaction time, transaction details, transaction amount, available account balance, etc.) of the financial transaction by the financial account holder.

In accordance with one or more embodiments set forth, illustrated, and described herein, the child/dependent, via the financial institution mobile application executing on the second client device, may transmit a request to increase the maximum financial transaction threshold. The financial account holder may, via the financial institution mobile application executing on the client device, approve or disapprove the request, which in turn will be transmitted to the second mobile device.

In accordance with one or more embodiments set forth, illustrated, and described herein, an apparatus may comprise one or more of the following: one or more processors; and a non-transitory memory coupled to the one or more processors, the non-transitory memory including a set of instructions of computer-executable program code, which when executed by the one or more processors, cause the apparatus to: receive, from a client device of a user having one or more primary financial accounts at a financial institution, a designation of a legal minor/dependent as a beneficiary to a user-designated beneficiary financial account that is associated with the one or more primary financial accounts; detect, in response to the designation, a financial transaction having a monetary amount that is paid by the legal minor/dependent using a user-authorized financial payment instrument associated with the user-designated beneficiary financial account; execute, in response to the detection, financial transaction analysis based on stored user account settings data associated with the user-designated beneficiary financial account; and transmit, in response to the execution, an electronic alert to the client device that includes a user-engageable link that, when engaged by the user, facilitates viewing of a transaction history of the financial transaction.

In accordance with one or more embodiments set forth, illustrated, and described herein, an apparatus may comprise one or more of the following: one or more processors; and a non-transitory memory coupled to the one or more processors, the non-transitory memory including a set of instructions of computer-executable program code, which when executed by the one or more processors, cause the apparatus to: receive, from a client device of a user having one or more primary financial accounts at a financial institution, a designation of a legal minor/dependent as a beneficiary to a user-designated beneficiary financial account that is associated with the one or more primary financial accounts; store the designation in the non-transitory memory; detect, in response to the designation, a financial transaction having a monetary amount that is paid by the legal minor/dependent using a user-authorized financial payment instrument associated with the user-designated beneficiary financial account; execute, in response to the detection, financial transaction analysis based on stored user account settings data associated with the user-designated beneficiary financial account; and transmit, in response to the execution, an electronic alert to the client device that includes a user-engageable link that, when engaged by the user, facilitates viewing of a transaction history of the financial transaction.

In accordance with one or more embodiments set forth, illustrated, and described herein, an apparatus may comprise one or more of the following: one or more processors; and a non-transitory memory coupled to the one or more processors, the non-transitory memory including a set of instructions of computer-executable program code, which when executed by the one or more processors, cause the apparatus to: detect a financial transaction having a monetary amount that is paid by a legal minor/dependent using a user-authorized financial payment instrument associated with a user-designated beneficiary financial account at a financial institution that is associated with one or more primary financial accounts of a user; execute, in response to the detection, financial transaction analysis based on stored user account settings data associated with the user-designated beneficiary financial account; and transmit, in response to the execution, an electronic alert to a client device of the user that includes a user-engageable link that, when engaged by the user, facilitates viewing of a transaction history of the financial transaction.

In accordance with each respective apparatus, the set of instructions, which when executed by the one or more processors, cause the apparatus to receive, from the client device of the user, a predetermined maximum financial transaction threshold.

In accordance with each respective apparatus, the set of instructions, which when executed by the one or more processors, cause the apparatus to store the predetermined maximum financial transaction threshold in the non-transitory memory.

In accordance with each respective apparatus, the set of instructions, which when executed by the one or more processors, cause the apparatus to execute the financial transaction analysis by determining if the monetary amount of the financial transaction is greater than the predetermined maximum financial transaction threshold.

In accordance with each respective apparatus, the set of instructions, which when executed by the one or more processors, cause the apparatus to execute the financial transaction analysis by conducting a comparison between the monetary amount and the predetermined maximum financial transaction threshold.

In accordance with each respective apparatus, the set of instructions, which when executed by the one or more processors, cause the apparatus to receive, from the client device of the user, a predetermined minimum financial transaction threshold.

In accordance with each respective apparatus, the set of instructions, which when executed by the one or more processors, cause the apparatus to store the predetermined minimum financial transaction threshold in the non-transitory memory.

In accordance with each respective apparatus, the set of instructions, which when executed by the one or more processors, cause the apparatus to execute the financial transaction analysis by determining if the monetary amount of the financial transaction is less than the predetermined minimum financial transaction threshold.

In accordance with each respective apparatus, the set of instructions, which when executed by the one or more processors, cause the apparatus to execute the financial transaction analysis by conducting a comparison between the monetary amount and the predetermined minimum financial transaction threshold.

In accordance with each respective apparatus, the set of instructions, which when executed by the one or more processors, cause the apparatus to detect, in response to the detection of the financial transaction, execution of a software mobile application associated with the financial institution on the client device.

In accordance with each respective apparatus, the set of instructions, which when executed by the one or more processors, cause the apparatus to cause, in response to the detection of the execution of the mobile application, display of a graphical user interface (GUI) on a user interface of the client device, the GUI comprising a visual alert of the transaction history of the financial transaction.

In accordance with each respective apparatus, the set of instructions, which when executed by the one or more processors, cause the apparatus to receive, from a second client device of the legal minor/dependent, a request to increase the predetermined maximum financial transaction threshold to a specified monetary amount.

In accordance with each respective apparatus, the set of instructions, which when executed by the one or more processors, cause the apparatus to cause, in response to the receipt of the request, display of a graphical user interface (GUI) on a user interface of the client device, the GUI comprising a visual alert of the request and a first user-engageable icon to approve the request and a second user-engageable icon to deny the request.

In accordance with each respective apparatus, the set of instructions, which when executed by the one or more processors, cause the apparatus to transmit, in response to the receipt of the request, an electronic alert (e.g., email, text, pop-up, etc.) to the client device that includes a user-engageable link that, when engaged by the user, causes display of a graphical user interface (GUI) on a user interface of the client device, the GUI comprising a visual alert of the request and a first user-engageable icon to approve the request and a second user-engageable icon to deny the request.

In accordance with each respective apparatus, the set of instructions, which when executed by the one or more processors, cause the apparatus to increase, in response to receipt of an approval of the request by the client device, the predetermined maximum financial transaction threshold to the specified monetary amount.

In accordance with each respective apparatus, the set of instructions, which when executed by the one or more processors, cause the computing device to transmit, in response to receipt of an approval of the request from the first client device, an electronic alert to the second client device that includes an indication of whether the request was approved or denied.

In accordance with one or more embodiments set forth, illustrated, and described herein, a computer program product comprising at least one non-transitory computer readable medium having with a set of instructions of computer-executable program code, which when executed by one or more processors of a computing device, cause the computing device to execute one or more of the following: receive, from a client device of a user having one or more primary financial accounts at a financial institution, a designation of a legal minor/dependent as a beneficiary to a user-designated beneficiary financial account that is associated with the one or more primary financial accounts; detect, in response to the designation, a financial transaction having a monetary amount that is paid by the legal minor/dependent using a user-authorized financial payment instrument associated with the user-designated beneficiary financial account; execute, in response to the detection, financial transaction analysis based on stored user account settings data associated with the user-designated beneficiary financial account; and transmit, in response to the execution, an electronic alert to the client device that includes a user-engageable link that, when engaged by the user, facilitates viewing of a transaction history of the financial transaction.

In accordance with one or more embodiments set forth, illustrated, and described herein, a computer program product comprising at least one non-transitory computer readable medium having with a set of instructions of computer-executable program code, which when executed by one or more processors of a computing device, cause the computing device to execute one or more of the following: receive, from a client device of a user having one or more primary financial accounts at a financial institution, a designation of a legal minor/dependent as a beneficiary to a user-designated beneficiary financial account that is associated with the one or more primary financial accounts; store the designation in the non-transitory memory; detect, in response to the designation, a financial transaction having a monetary amount that is paid by the legal minor/dependent using a user-authorized financial payment instrument associated with the user-designated beneficiary financial account; execute, in response to the detection, financial transaction analysis based on stored user account settings data associated with the user-designated beneficiary financial account; and transmit, in response to the execution, an electronic alert to the client device that includes a user-engageable link that, when engaged by the user, facilitates viewing of a transaction history of the financial transaction.

In accordance with one or more embodiments set forth, illustrated, and described herein, a computer program product comprising at least one non-transitory computer readable medium having with a set of instructions of computer-executable program code, which when executed by one or more processors of a computing device, cause the computing device to execute one or more of the following: one or more processors; and a non-transitory memory coupled to the one or more processors, the non-transitory memory including a set of instructions of computer-executable program code, which when executed by the one or more processors, cause the apparatus to: detect a financial transaction having a monetary amount that is paid by a legal minor/dependent using a user-authorized financial payment instrument associated with a user-designated beneficiary financial account at a financial institution that is associated with one or more primary financial accounts of a user; execute, in response to the detection, financial transaction analysis based on stored user account settings data associated with the user-designated beneficiary financial account; and transmit, in response to the execution, an electronic alert to a client device of the user that includes a user-engageable link that, when engaged by the user, facilitates viewing of a transaction history of the financial transaction.

In accordance with each respective computer program product, the set of instructions, which when executed by the one or more processors, cause the computing device to receive, from the client device of the user, a predetermined maximum financial transaction threshold.

In accordance with each respective computer program product, the set of instructions, which when executed by the one or more processors, cause the computing device to store the predetermined maximum financial transaction threshold in the non-transitory memory.

In accordance with each respective computer program product, the set of instructions, which when executed by the one or more processors, cause the computing device to execute the financial transaction analysis by determining if the monetary amount of the financial transaction is greater than the predetermined maximum financial transaction threshold.

In accordance with each respective computer program product, the set of instructions, which when executed by the one or more processors, cause the computing device to execute the financial transaction analysis by conducting a comparison between the monetary amount and the predetermined maximum financial transaction threshold.

In accordance with each respective computer program product, the set of instructions, which when executed by the one or more processors, cause the computing device to receive, from the client device of the user, a predetermined minimum financial transaction threshold.

In accordance with each respective computer program product, the set of instructions, which when executed by the one or more processors, cause the computing device to store the predetermined minimum financial transaction threshold in the non-transitory memory.

In accordance with each respective computer program product, the set of instructions, which when executed by the one or more processors, cause the computing device to execute the financial transaction analysis by determining if the monetary amount of the financial transaction is less than the predetermined minimum financial transaction threshold.

In accordance with each respective computer program product, the set of instructions, which when executed by the one or more processors, cause the computing device to execute the financial transaction analysis by conducting a comparison between the monetary amount and the predetermined minimum financial transaction threshold.

In accordance with each respective computer program product, the set of instructions, which when executed by the one or more processors, cause the computing device to detect, in response to the detection of the financial transaction, execution of a software mobile application associated with the financial institution on the client device.

In accordance with each respective computer program product, the set of instructions, which when executed by the one or more processors, cause the computing device to cause, in response to the detection of the execution of the mobile application, display of a graphical user interface (GUI) on a user interface of the client device, the GUI comprising a visual alert of the transaction history of the financial transaction.

In accordance with each respective computer program product, the set of instructions, which when executed by the one or more processors, cause the computing device to receive, from a second client device of the legal minor/dependent, a request to increase the predetermined maximum financial transaction threshold to a specified monetary amount.

In accordance with each respective computer program product, the set of instructions, which when executed by the one or more processors, cause the computing device to cause, in response to the receipt of the request, display of a graphical user interface (GUI) on a user interface of the client device, the GUI comprising a visual alert of the request and a first user-engageable icon to approve the request and a second user-engageable icon to deny the request.

In accordance with each respective computer program product, the set of instructions, which when executed by the one or more processors, cause the computing device to transmit, in response to the receipt of the request, an electronic alert (e.g., email, text, pop-up, etc.) to the client device that includes a user-engageable link that, when engaged by the user, causes display of a graphical user interface (GUI) on a user interface of the client device, the GUI comprising a visual alert of the request and a first user-engageable icon to approve the request and a second user-engageable icon to deny the request.

In accordance with each respective computer program product, the set of instructions, which when executed by the one or more processors, cause the computing device to increase, in response to receipt of an approval of the request by the client device, the predetermined maximum financial transaction threshold to the specified monetary amount.

In accordance with each respective computer program product, the set of instructions, which when executed by the one or more processors, cause the computing device to transmit, in response to receipt of an approval of the request from the first client device, an electronic alert to the second client device that includes an indication of whether the request was approved or denied.

In accordance with one or more embodiments set forth, illustrated, and described herein, a computer-implemented method may comprise one or more of the following: receiving, by one or more financial institution servers associated with a financial institution from a client device of a user executing a mobile application associated with the financial institution, a designation of a legal minor/dependent as a beneficiary to a user-designated beneficiary financial account that is associated with one or more primary financial accounts of the user at the financial institution; detecting, by the by one or more financial institution servers in response to the designation, a financial transaction having a monetary amount that is paid by the legal minor/dependent using a user-authorized financial payment instrument associated with the user-designated beneficiary financial account; executing, by the by one or more financial institution servers in response to the detection, financial transaction analysis based on stored user account settings data associated with the user-designated beneficiary financial account; and transmitting, by the by one or more financial institution servers in response to the execution, an electronic alert to the client device that includes a user-engageable link that, when engaged by the user, facilitates viewing of a transaction history of the financial transaction.

In accordance with one or more embodiments set forth, illustrated, and described herein, a computer-implemented method may comprise one or more of the following: receiving, by one or more financial institution servers associated with a financial institution from a client device of a user executing a mobile application associated with the financial institution, a designation of a legal minor/dependent as a beneficiary to a user-designated beneficiary financial account that is associated with one or more primary financial accounts of the user at the financial institution; storing, by the one or more financial institution servers, the designation in the non-transitory memory; detecting, by the one or more financial institution servers in response to the designation, a financial transaction having a monetary amount that is paid by the legal minor/dependent using a user-authorized financial payment instrument associated with the user-designated beneficiary financial account; executing, by the one or more financial institution servers in response to the detection, financial transaction analysis based on stored user account settings data associated with the user-designated beneficiary financial account; and transmitting, by the one or more financial institution servers in response to the execution, an electronic alert to the client device that includes a user-engageable link that, when engaged by the user, facilitates viewing of a transaction history of the financial transaction.

In accordance with one or more embodiments set forth, illustrated, and described herein, a computer-implemented method may comprise one or more of the following: detecting, by one or more financial institution servers associated with a financial institution, a financial transaction having a monetary amount that is paid by a legal minor/dependent using a user-authorized financial payment instrument associated with a user-designated beneficiary financial account at the financial institution that is associated with one or more primary financial accounts of a user; executing, by the one or more financial institution servers in response to the detection, financial transaction analysis based on stored user account settings data associated with the user-designated beneficiary financial account; and transmitting, by the one or more financial institution servers in response to the execution, an electronic alert to a client device of the user that includes a user-engageable link that, when engaged by the user, facilitates viewing of a transaction history of the financial transaction.

In accordance with each respective computer-implemented method, further comprising, by the one or more financial institution servers, receiving, from the client device of the user, a predetermined maximum financial transaction threshold.

In accordance with each respective computer-implemented method, further comprising, by the one or more financial institution servers, storing the predetermined maximum financial transaction threshold in the non-transitory memory.

In accordance with each respective computer-implemented method, further comprising, by the one or more financial institution servers, executing the financial transaction analysis by determining if the monetary amount of the financial transaction is greater than the predetermined maximum financial transaction threshold.

In accordance with each respective computer-implemented method, further comprising, by the one or more financial institution servers, executing the financial transaction analysis by conducting a comparison between the monetary amount and the predetermined maximum financial transaction threshold.

In accordance with each respective computer-implemented method, further comprising, by the one or more financial institution servers, receiving, from the client device of the user, a predetermined minimum financial transaction threshold.

In accordance with each respective computer-implemented method, further comprising, by the one or more financial institution servers, storing the predetermined minimum financial transaction threshold in the non-transitory memory.

In accordance with each respective computer-implemented method, further comprising, by the one or more financial institution servers, executing the financial transaction analysis by determining if the monetary amount of the financial transaction is less than the predetermined minimum financial transaction threshold.

In accordance with each respective computer-implemented method, further comprising, by the one or more financial institution servers, executing the financial transaction analysis by conducting a comparison between the monetary amount and the predetermined minimum financial transaction threshold.

In accordance with each respective computer-implemented method, further comprising, by the one or more financial institution servers, detecting, in response to the detection of the financial transaction, execution of a software mobile application associated with the financial institution (“financial institution mobile application”) on the client device.

In accordance with each respective computer-implemented method, further comprising, by the one or more financial institution servers, causing, in response to the detection of the execution of the mobile application, display of a graphical user interface (GUI) on a user interface of the client device, the GUI comprising a visual alert of the transaction history of the financial transaction.

In accordance with each respective computer-implemented method, further comprising, by the one or more financial institution servers, receiving, from a second client device of the legal minor/dependent, a request to increase the predetermined maximum financial transaction threshold to a specified monetary amount.

In accordance with each respective computer-implemented method, further comprising, by the one or more financial institution servers, causing, in response to the receipt of the request, display of a graphical user interface (GUI) on a user interface of the client device, the GUI comprising a visual alert of the request and a first user-engageable icon to approve the request and a second user-engageable icon to deny the request.

In accordance with each respective computer-implemented method, further comprising, by the one or more financial institution servers, transmitting, in response to the receipt of the request, an electronic alert (e.g., email, text, pop-up, etc.) to the client device that includes a user-engageable link that, when engaged by the user, causes display of a graphical user interface (GUI) on a user interface of the client device, the GUI comprising a visual alert of the request and a first user-engageable icon to approve the request and a second user-engageable icon to deny the request.

In accordance with each respective computer-implemented method, further comprising, by the one or more financial institution servers, increasing, in response to receipt of an approval of the request by the client device, the predetermined maximum financial transaction threshold to the specified monetary amount.

In accordance with each respective computer-implemented method, further comprising, by the one or more financial institution servers, transmitting, in response to receipt of an approval of the request from the first client device, an electronic alert to the second client device that includes an indication of whether the request was approved or denied.

In accordance with one or more embodiments set forth, illustrated, and described herein, the user-authorized financial payment instrument comprises a physical debit card.

In accordance with one or more embodiments set forth, illustrated, and described herein, the user-authorized financial payment instrument comprises a virtual debit card.

In accordance with one or more embodiments set forth, illustrated, and described herein, the user-authorized financial payment instrument comprises a mobile wallet.

In accordance with one or more embodiments set forth, illustrated, and described herein, the beneficiary is a legal minor/dependent of the financial account holder.

### DRAWINGS

The various advantages of the exemplary embodiments will become apparent to one skilled in the art by reading the following specification and appended claims, and by referencing the following drawings, in which:

FIG. 1 illustrates a communication environment, in accordance with one or more embodiments set forth and described herein.

FIG. 2 illustrates a block diagram of the first client device of FIG. 1.

FIG. 3 illustrates a block diagram of the second client device of FIG. 1.

FIG. 4 illustrates a block diagram of the one or more financial institution servers of FIG. 1.

FIGS. 5 through 12 respectively illustrate a GUI for visual display on a user interface of a client device, in accordance with one or more embodiments set forth and described herein.

FIGS. 13 through 15 respectively illustrate a computer-implemented method, in accordance with one or more embodiments set forth and described herein.

### DESCRIPTION

Hereinbelow are example definitions that are provided only for illustrative purposes in this disclosure, and should not be construed to limit the scope of the one or more embodiments disclosed herein in any manner. Some terms are defined below for purposes of clarity. These terms are not rigidly restricted to these definitions. This disclosure contemplates that these terms and other terms may also be defined by their use in the context of this description.

As used herein, “application” relates to software used on a computer (usually by a client and/or client device and can be applications that are targeted or supported by specific classes of machine, such as a mobile application, desktop application, tablet application, and/or enterprise application (e.g., client device application(s) on a client device). Applications may be separated into applications which reside on a client device (e.g., VPN, PowerPoint, Excel) and cloud applications which may reside in the cloud (e.g., Gmail, GitHub). Cloud applications may correspond to applications on the client device or may be other types such as social media applications (e.g., Facebook).

As used herein, “artificial intelligence (AI)” relates to one or more computer system operable to perform one or more tasks that normally require human intelligence, such as visual perception, speech recognition, decision-making, and translation between languages.

As used herein, “machine learning” relates to an application of AI that provides computer systems the ability to automatically learn and improve from data and experience without being explicitly programmed.

As used herein, “computer” relates to a single computer or to a system of interacting computers. A computer is a combination of a hardware system, a software operating system and perhaps one or more software application programs. Examples of a computer include without limitation a personal computer (PC), laptop computer, a smart phone, a cell phone, or a wireless tablet.

As used herein, “client device” relates to any device associated with a user, including personal computers, laptops, tablets, and/or mobile smartphones.

As used herein, “modules” relates to either software modules (e.g., code embodied on a machine-readable medium or in a transmission signal) or hardware modules. Certain embodiments are described herein as including logic or a number of components, modules, or mechanisms. A “hardware module” (or just “hardware”) as used herein is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as an FPGA or an ASIC. A hardware module may also include programmable logic or circuitry that is temporarily configured by software to perform certain operations. A hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access.

As used herein, “network” or “networks” relates to any combination of electronic communication networks, including without limitation the Internet, a local area network (LAN), a wide area network, a wireless network, and a cellular network (e.g., 4G, 5G).

As used herein, “processes” or “methods” are presented in terms of processes (or methods) or symbolic representations of operations on data stored as bits or binary digital signals within a machine memory (e.g., a computer memory). These processes or symbolic representations are examples of techniques used by those of ordinary skill in the data processing arts to convey the substance of their work to others skilled in the art. As used herein, a “process” is a self-consistent sequence of operations or similar processing leading to a desired result. In this context, processes and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information.

As used herein, “processor-Implemented module” relates to a hardware module implemented using one or more processors. The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein.

As used herein, “server” relates to a server computer or group of computers that acts to provide a service for a certain function or access to a network resource. A server may be a physical server, a hosted server in a virtual environment, or software code running on a platform.

As used herein, “service” or “application” relates to an online server (or set of servers), and can refer to a web site and/or web application.

As used herein, “software” relates to a set of instructions and associated documentations that tells a computer what to do or how to perform a task. Software includes all different software programs on a computer, such as applications and the operating system. A software application could be written in substantially any suitable programming language, which could easily be selected by one of ordinary skill in the art. The programming language chosen should be compatible with the computer by which the software application is to be executed and, in particular, with the operating system of that computer. Examples of suitable programming languages include without limitation Object Pascal, C, C++, CGI, Java, and Java Scripts. Further, the functions of some embodiments, when described as a series of steps for a method, could be implemented as a series of software instructions for being operated by a processor, such that the embodiments could be implemented as software, hardware, or a combination thereof.

As used herein, “sensor” relates to any device, component and/or system that can perform one or more of detecting, determining, assessing, monitoring, measuring, quantifying, and sensing something.

As used herein, “real-time” relates to a level of processing responsiveness that a user, module, or system senses as sufficiently immediate for a particular process or determination to be made, or that enables the processor to keep up with some external process.

As used herein, “user” relates to a consumer, machine entity, and/or requesting party, and may be human or machine.

Upon the launching of a GUI comprising a dashboard of financial institution on a client device, a user may receive data and information on one or more branch employees based on the geographic location of the user, or a user request or query for one or more financial services that are offered by the financial institution.

In accordance with one or more embodiments set forth, illustrated, and described herein, a communication environment that delivers enhanced digital financial services while promoting financial literacy in a manner that also establishes financial credit in the name of a legal minor/dependent. A user, i.e., a financial account holder having one or more primary financial accounts at the financial institution, is given a digital platform to maintain one or more user-designated beneficiary financial accounts that are sub/secondary accounts to the primary financial account. The types of user-designated beneficiary financial accounts include, but is not limited to, any user account associated with a personal account, a commercial account, and a wealth management account. Example accounts may include, but is not limited to, checking accounts, savings accounts, credit accounts, money market accounts (MMA), certificates of deposit (CD), lines-of-credit, etc. The one or more user-designated beneficiary financial accounts may be for the benefit of a legal minor/dependent, such as, for example, a child/dependent of the user. Each one of the subaccounts may be a savings account. The savings account could comprise an account held in trust for the benefit of the child/dependent. One or more payment instruments (e.g., a debit card or a mobile wallet) may be associated with the one or more user-designated beneficiary financial accounts. The one or more debit cards and mobile wallets facilitate the promotion of financial literacy to the child/dependent through responsible spending, while also establishing financial credit to the benefit of the child/dependent.

The digital platform facilitates dynamic monitoring by the user of transactions by a legal minor/dependent via a payment instrument (e.g., a debit card or a mobile wallet) associated with the one or more user-designated beneficiary financial accounts. The user, via a client device, may set a minimum financial transaction threshold and a maximum financial transaction threshold on each payment instrument. The minimum financial transaction threshold and the maximum financial transaction threshold may be associated with a temporal threshold, e.g., daily, weekly, monthly, annually, etc.

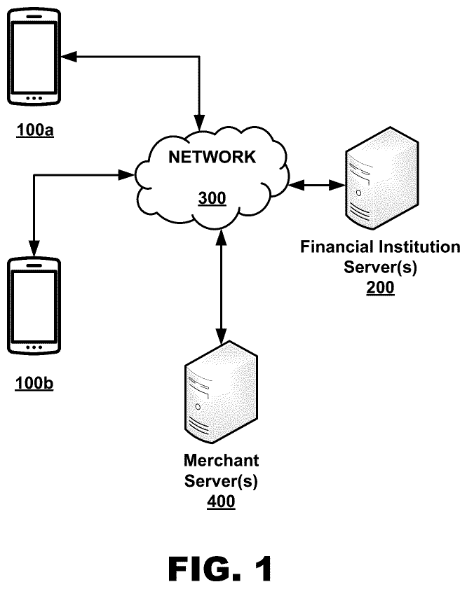

Turning to the figures, in which FIG. 1 illustrates a communication environment in which a user communicates with a financial institution over a communications network. A first client device 100a (of the financial account holder) and a second client device 100b (of the legal minor/dependent) operating in the communication environment facilitates user access to and user management of one or more financial accounts at one or more financial institution servers 200 of the financial institution. The communication environment includes the first client device 100a, the second client device 100b, the one or more financial institution servers 200, and a communication network 300 through which communication is facilitated between the first client device 100a, the second client device 100b, the one or more financial institution servers 200, and one or more merchant servers 400 of a merchant.

In accordance with one or more embodiments set forth, described, and/or illustrated herein, the first client device 100a and the second client device 100b respectively comprise a computing device, including but not limited to a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the first client device 100a and the second client device 100b comprising any form of electronic device that optimizes or otherwise transforms the performance and functionality of the one or more embodiments in a manner that falls within the spirit and scope of the principles of this disclosure.

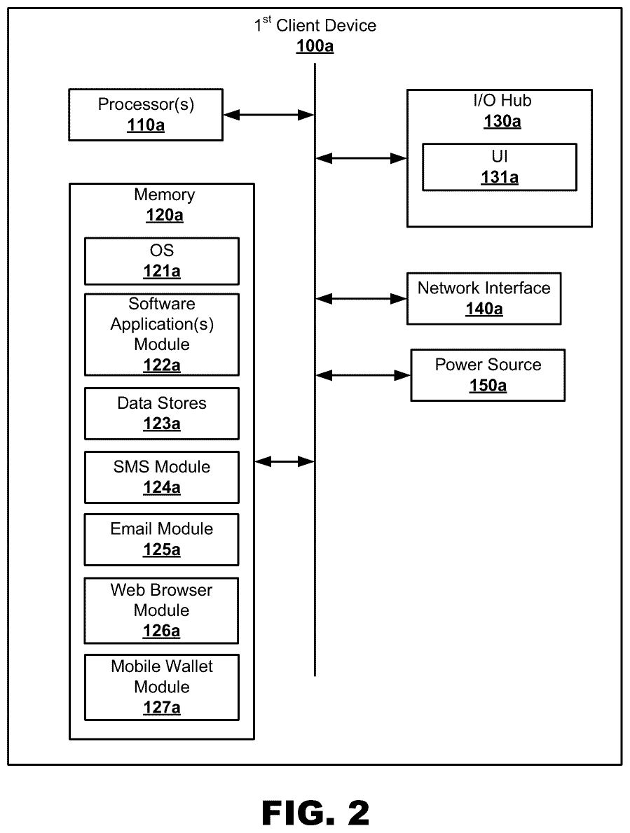

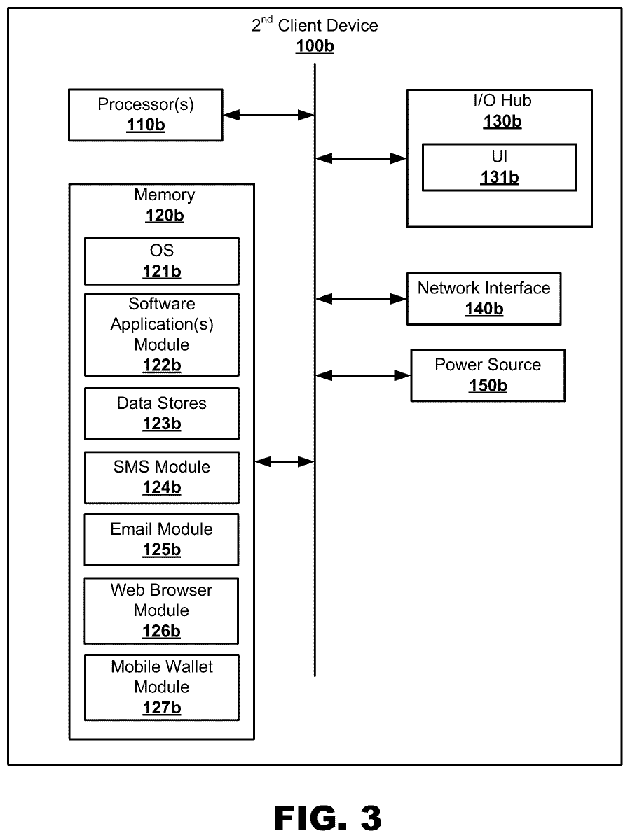

In the illustrated example embodiment of FIGS. 2 and 3, the first client device 100a and the second client device 100b comprise mobile devices. Some of the possible operational elements of the first client device 100a and the second client device 100b are illustrated in FIGS. 2 and 3 and will now be described herein. It will be understood that it is not necessary for the first client device 100a and the second client device 100b to have all the elements illustrated in FIGS. 2 and 3. For example, the first client device 100a and the second client device 100b may have any combination of the various elements illustrated in FIGS. 2 and 3. Moreover, the first client device 100a and the second client device 100b may have additional elements to those illustrated in FIGS. 2 and 3.

The first client device 100a and the second client device 100b includes one or more processors 110a, 110b, a non-transitory memory 120a, 120b operatively coupled to the one or more processors 110a 110b, an I/O hub 130a, 130b, a network interface 140a, 140b, and a power source 150a, 150b.

The memory 120a, 120b comprises a set of instructions of computer-executable program code. The set of instructions are executable by the one or more processors 110a, 110b to cause execution of an operating system 121a, 121b and one or more software applications of a software application module 122a, 122b that reside in the memory 120a, 120b. The one or more software applications residing in the memory 120a, 120b includes, but is not limited to, a financial institution application that is associated with the financial institution. The financial institution application comprises a mobile application that facilitates establishment of a secure connection between the first client device 100a and the second client device 100b and the one or more financial institution servers 200. The one or more processors 110a, 110b are operable to execute the mobile application to facilitate user access to the one or more user accounts and user management of the one or more user accounts.

The memory 120a, 120b also includes one or more data stores 123a, 123b that are operable to store one or more types of data. The mobile device 100A may include one or more interfaces that facilitate one or more systems or modules thereof to transform, manage, retrieve, modify, add, or delete, the data residing in the data stores 123a, 123b. The one or more data stores 123a, 123b may comprise volatile and/or non-volatile memory. Examples of suitable data stores 123A include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 123a, 123b may be a component of the one or more processors 110a, 110b, or alternatively, may be operatively connected to the one or more processors 110a, 110b for use thereby. As set forth, described, and/or illustrated herein, “operatively connected” may include direct or indirect connections, including connections without direct physical contact.

The memory 120a, 120b also includes an SMS module 124a, 124b operable to facilitate user transmission and receipt of text messages via the first client device 100a and the second client device 100b though the network 300. In one example embodiment, a user may receive text messages from the financial institution that are associated with the user access and the user management of the one or more user accounts. An email module 125a, 125b is operable to facilitate user transmission and receipt of email messages via the first client device 100a and the second client device 100b through the network 300. In one example embodiment, a user may receive email messages from the financial institution that are associated with the user access and the user management of the one or more user accounts. A user may utilize a web browser module 126a, 126b that is operable to facilitate user access to one or more websites associated with the financial institution through the network 300. A mobile wallet module 127a, 127b facilitates the generation of one or more mobile wallets associated with the one or more user-designated beneficiary financial accounts.

In accordance with one or more embodiments set forth, described, and/or illustrated herein, the first client device 100a and the second client device 100b include an I/O hub 130a, 130b operatively connected to other systems and subsystems of the mobile device 100A. The I/O system 130a, 130b may include one or more of an input interface, an output interface, and a network controller to facilitate communications between the first client device 100a, the second client device 100b, and the server 200. The input interface and the output interface may be integrated as a single, unitary user interface 131A, or alternatively, be separate as independent interfaces that are operatively connected.

As used herein, the input interface is defined as any device, software, component, system, element, or arrangement or groups thereof that enable information and/or data to be entered as input commands by a user in a manner that directs the one or more processors 110a, 110b to execute instructions. The input interface may comprise a user interface (UI), a graphical user interface (GUI), such as, for example, a display, human-machine interface (HMI), or the like. Embodiments, however, are not limited thereto, and thus, this disclosure contemplates the input interface comprising a keypad, touch screen, multi-touch screen, button, joystick, mouse, trackball, microphone and/or combinations thereof.

As used herein, the output interface is defined as any device, software, component, system, element or arrangement or groups thereof that enable information/data to be presented to a user. The output interface may comprise one or more of a visual display or an audio display, including, but not limited to, a microphone, earphone, and/or speaker. One or more components of the first client device 100a and the second client device 100b may serve as both a component of the input interface and a component of the output interface.

The first client device 100a and the second client device 100b include a network interface 140a, 140b operable to facilitate connection to the network 300. The first client device 100a and the second client device 100b also include a power source 150a, 150b that comprises a wired powered source, a wireless power source, a replaceable battery source, or a rechargeable battery source.

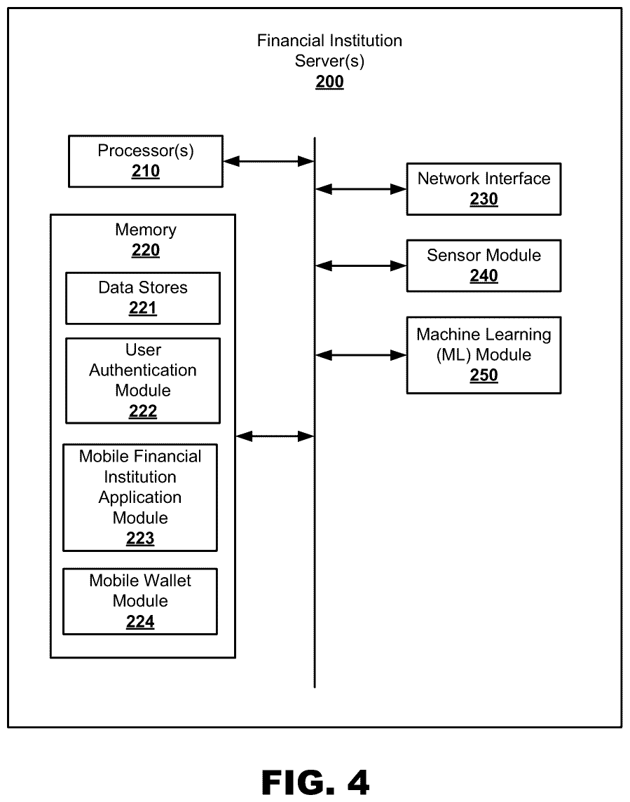

As illustrated in FIG. 4, the one or more financial institution servers 200 includes one or more processors 210, a non-transitory memory 220 operatively coupled to the one or more processors 210, a network interface 230, a sensor module 240, and a machine learning (ML) module 250. Some of the possible operational elements of each server in the one or more financial institution servers 200 are illustrated in FIG. 4 and will now be described herein. It will be understood that it is not necessary for each server in the one or more financial institution servers 200 to have all the elements illustrated in FIG. 4. For example, each server in the one or more financial institution servers 200 may have any combination of the various elements illustrated in FIG. 4. Moreover, each server in the one or more financial institution servers 200 may have additional elements to those illustrated in FIG. 4.

The one or more financial institution servers 200 may be controlled by a system manager (or policy manager) of the financial institution.

In accordance with one or more embodiments set forth, described, and/or illustrated herein, the one or more financial institution servers 200 may comprise a computing device, including but not limited to a server computer, a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the one or more financial institution servers 200 comprising any form of electronic device that optimizes or otherwise transforms the performance and functionality of the one or more embodiments in a manner that falls within the spirit and scope of the principles of this disclosure.

The memory 220 comprises a set of instructions of computer-executable program code. The set of instructions are executable by the one or more processors 210 in manner that facilitates control of a user authentication module 222, a mobile financial institution application module 223 having one or more mobile financial institution applications that reside in the memory 220, and a mobile wallet module 224. In accordance with one or more embodiments set forth, described, and/or illustrated herein, the one or more financial institution servers 200 may individually or collectively execute the instructions to perform any one or more of the methodologies set forth, described, and illustrated herein.

The memory 220 also includes one or more data stores 221 that are operable to store one or more types of data, including but not limited to, user account data, user authentication data, sensor data, etc. The one or more data stores 221 may comprise volatile and/or non-volatile memory. Examples of suitable data stores 221 include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 221 may be a component of the one or more processors 210, or alternatively, may be operatively connected to the one or more processors 210 for use thereby. As set forth, described, and/or illustrated herein, “operatively connected” may include direct or indirect connections, including connections without direct physical contact.

The memory 220 may include a single machine-readable medium, or a plurality of media (e.g., a centralized or distributed database, or associated caches and servers) operable to store the instructions. The term “machine-readable medium” shall also be taken to include any medium, or combination of multiple media, that is capable of storing instructions (e.g., software) for execution by a server (e.g., server), such that the instructions, when executed by the one or more processors 210, cause the one or more financial institution servers 200 to perform any one or more of the methodologies set forth, described, and illustrated herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

The computer-executable program code may instruct the one or more processors 210 to cause the user authentication module 221 to authenticate a user in order to gain user access to the one or more user accounts. The user authentication module 221 may be caused to request user input user data or user identification that include, but are not limited to, user identity (e.g., username), a user passcode, a cookie, user biometric data, a private key, a token, and/or another suitable authentication data or information.

The computer-executable program code may instruct the one or more processors 210 to execute certain logic, data-processing, and data-storing functions of the one or more financial institution servers 200, in addition to certain communication functions of the one or more financial institution servers 200. The one or more mobile financial institution applications of the mobile financial institution application module 222 are operable to communicate with the first client device 100a and the second client device 100b in a manner which facilitates user access to the one or more user accounts in addition to user management of the one or more user accounts based on successful user authentication.

The sensor module 240 is operable, at least during execution of the mobile application by the client device 100, to dynamically detect, determine, assess, monitor, measure, quantify, and/or sense information about the client device 100. The sensor module 240 may be operable to detect, determine, assess, monitor, measure, quantify and/or sense in real-time. The sensor module 240 may be operable to detect, determine, assess, monitor, measure, quantify, and/or sense geographic location information about the geographic location of the client device 100.

The ML module 250 may include one or more ML algorithms to train one or more machine learning models of the one or more financial institution servers 200 based on data and/or information resided in the memory 220. The ML algorithms may include one or more of a linear regression algorithm, a logical regression algorithm, or a combination of different algorithms. A neural network may also be used to train the system based on the received data. The ML module 250 may analyze the received data and/or information, and transform the data and/or information in a manner which provides enhanced communication between the client device 100 and the one or more financial institution servers 200, while also enhancing user access and management of the one or more user accounts. The data and/or information may also be up-linked to other systems and modules in the one or more financial institution servers 200 for further processing to discover additional information that may be used to enhance the understanding of the information.

In accordance with one or more embodiments set forth, described, and/or illustrated herein, the network 300 may comprise a wireless network, a wired network, or any suitable combination thereof. For example, the network 300 is operable to support connectivity using any protocol or technology, including, but not limited to wireless cellular, wireless broadband, wireless local area network (WLAN), wireless personal area network (WPAN), wireless short distance communication, Global System for Mobile Communication (GSM), or any other suitable wired or wireless network operable to transmit and receive a data signal.

In accordance with one or more embodiments set forth, described, and/or illustrated herein, a user may, via the client device 100, execute a mobile application associated with the financial institution over the communication network 300. Upon being authenticated by the user authentication module 221, the user may transmit via the client device 100, a service request or query to the one or more financial institution servers 200 for one or more financial services that are offered by the financial institution. Such financial services may include, but are not limited to, a round-up savings program offered by the financial institution.

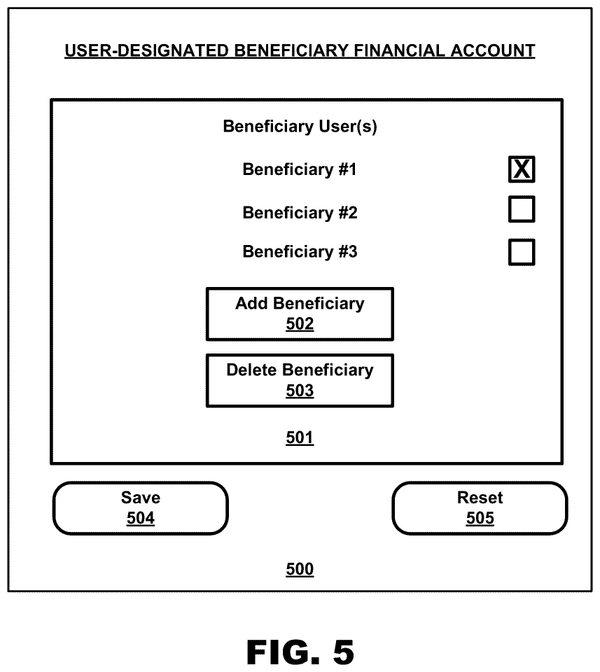

As illustrated in FIG. 5, the computer-executable program code may instruct the one or more processors 210 to cause (e.g., via the mobile financial institution application module 223), over the communication network 300 via a software application associated with the financial institution (“financial institution software application”), the display, generation, or rendering of a GUI comprising a dashboard 500 for visual display on the user interface 131a of the first client device 100a.

The computer-executable program code may instruct the one or more processors 210 to cause the round-up savings module 224 to generate or otherwise render a widget on the dashboard 500, the widget having a tile 501 with one or more user-engageable checkboxes to facilitate the selective designation by the user of one or more of legal minor/dependents as a beneficiary to a user-designated beneficiary financial account that is associated with one or more primary financial accounts maintained by the user at the financial institution. The tile 501 may also include one or more user-engageable icons 502, 503 to add a beneficiary or delete a previously-designated beneficiary. The tile 501 may further include one or more user-engageable icons 504, 505 to save the settings or reset the settings to a default settings status. This disclosure contemplates, temporally before displaying the dashboard 500, the computer-executable program code instructing the one or more processors 210 to cause, over the communication network 300 via the financial institution software application, a presentation to the first client device 100a an offer to establish one or more beneficiary financial accounts that is associated with the one or more primary financial accounts at the financial institution.

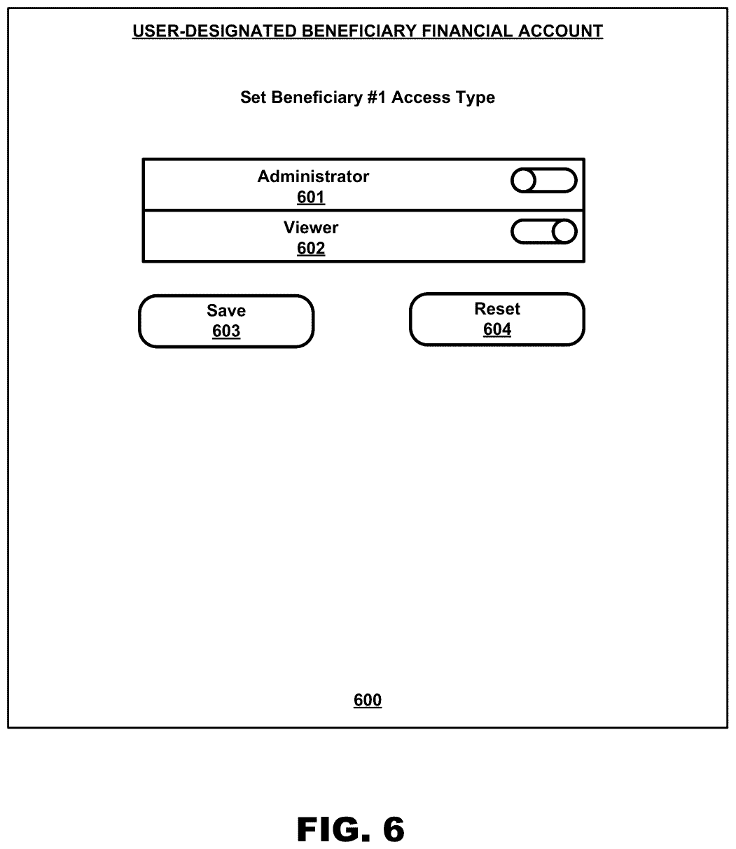

As illustrated in FIG. 6, in response to the user selectively one or more of legal minor/dependents as a beneficiary, the computer-executable program code may instruct the one or more processors 210 to cause, over the communication network 300 via the financial institution software application, the display, generation, or rendering of a GUI comprising a dashboard 600 having one or more user engageable tiles 601, 602 that allows the user to provide restrictions on the access the designated beneficiary may have with regards to the data and information associated with the user-designated beneficiary financial account. Although the user may, as the primary financial account holder, grant the designated beneficiary full-access as an administrator, this access level will be generally restricted by default. Otherwise, the designated beneficiary may be granted access as a viewer to only view data and information associated with the one or more user-designated beneficiary financial accounts. The tile 600 may further include one or more user-engageable icons 603, 604 to saves the settings or resets the settings to a default setting status.

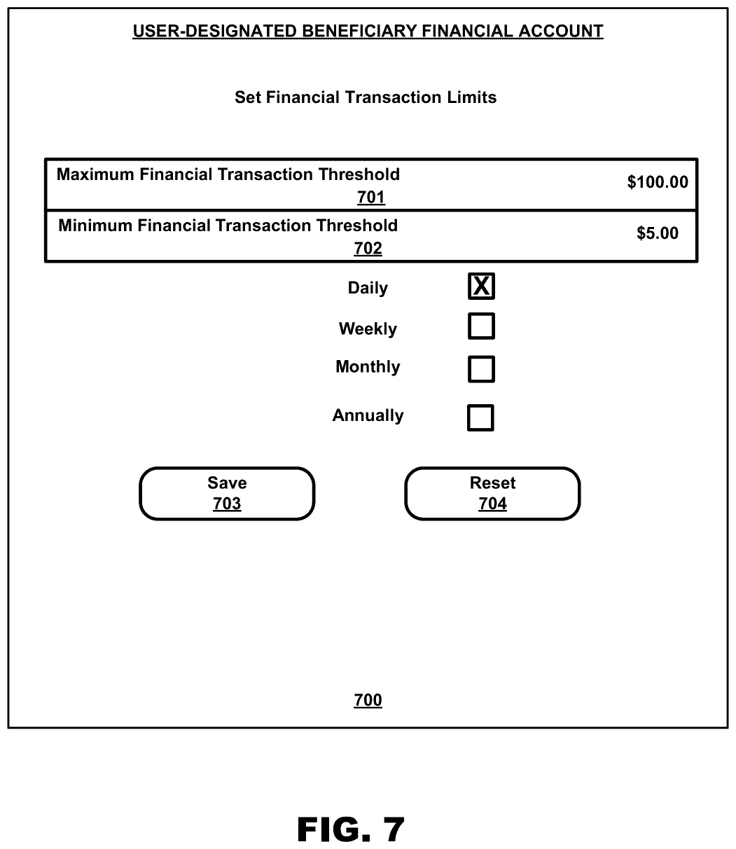

As illustrated in FIG. 7, in response to the user selectively designating one or more of legal minor/dependents as a beneficiary, the computer-executable program code may instruct the one or more processors 210 to cause, over the communication network 300 via the financial institution software application, the display, generation, or rendering of a GUI comprising a dashboard 700 for visual display on the user interface 131a of the first client device 100a. The dashboard 700 may comprise one or more tiles 701, 702 that permit the user to enter a predetermined maximum financial transaction threshold and a predetermined minimum financial transaction threshold.

The predetermined maximum financial transaction threshold represents a rule which places a limit or ceiling on a maximum accumulative monetary amount the beneficiary may engage in when using a user-authorized financial payment instrument associated with the user-designated beneficiary financial account. The predetermined minimum financial transaction threshold represents a rule which places a limit or floor on a minimum accumulative monetary amount the beneficiary may engage in when using the user-authorized financial payment instrument. The dashboard 700 may comprise one or more user-engageable checkboxes that permit a user to associate the minimum financial transaction threshold and the maximum financial transaction threshold with a temporal threshold, e.g., daily, weekly, monthly, annually, etc. The dashboard 700 may further include one or more user-engageable icons 703, 704 to save the settings or resets the settings to a default setting status.

In operation, the designated beneficiary may, via the mobile wallet module 127b of the second client device 100b, attempt a financial transaction to purchase goods or services at a certain monetary amount from a merchant using one or more payment instruments associated with the one or more user-designated beneficiary financial accounts. The financial transaction may occur via a communication environment comprising the first client device 100a, the second client device 100b, the one or more financial institution servers 200, the communication network 300, and the one or more merchant servers 400.

The computer-executable program code may instruct the one or more processors 210 to detect the financial transaction through the network 300. The computer-executable program code may instruct the one or more processors 210 to execute, in response to the detection, financial transaction analysis based on the previously-stored user account settings data associated with the user-designated beneficiary financial account.

For example, the computer-executable program code may instruct the one or more processors 210 to execute the financial transaction analysis by determining if the monetary amount of the financial transaction is greater than the predetermined maximum financial transaction threshold. In this regard, the computer-executable program code may instruct the one or more processors 210 to execute a comparison between the monetary amount and the predetermined maximum financial transaction threshold. The computer-executable program code may instruct the one or more processors 210 to execute the financial transaction analysis by determining if the monetary amount of the financial transaction is less than the predetermined minimum financial transaction threshold. In this regard, the computer-executable program code may instruct the one or more processors 210 to execute a comparison between the monetary amount and the predetermined minimum financial transaction threshold.

Should the monetary amount be less than the predetermined maximum financial transaction threshold and greater than the predetermined minimum financial transaction threshold, the computer-executable program code may instruct the one or more processors 210 to transmit an electronic signal to the one or more merchant servers 400 authorizing the financial transaction. Should, on the other hand, the monetary amount be greater than the predetermined maximum financial transaction threshold or less than the predetermined minimum financial transaction threshold, the computer-executable program code may instruct the one or more processors 210 to transmit an electronic signal to the one or more merchant servers 400 declining the financial transaction.

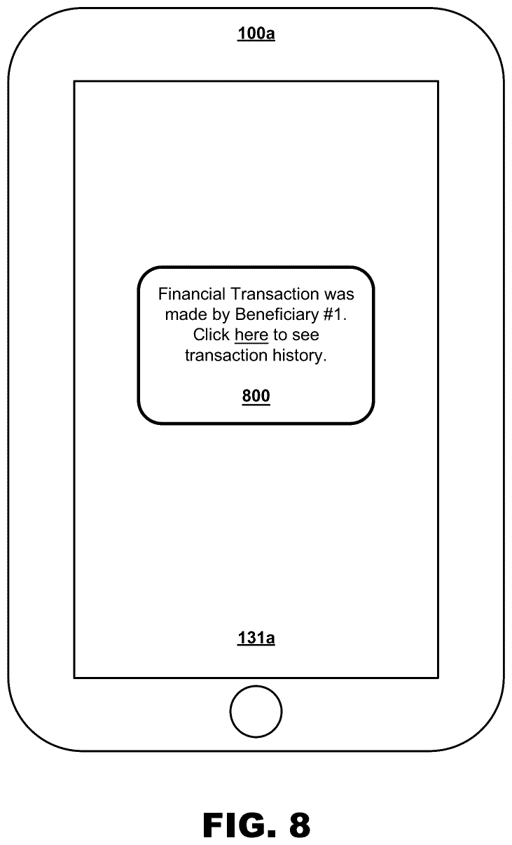

As illustrated in FIG. 8, the computer-executable program code may instruct the one or more processors 210 to, in response to the execution of the financial transaction analysis, transmit an electronic alert 801 for visual display on the user interface 131a of the first client device 100a. The electronic alert 801 may comprise an email, text, pop-up, etc. that includes a user-engageable link.

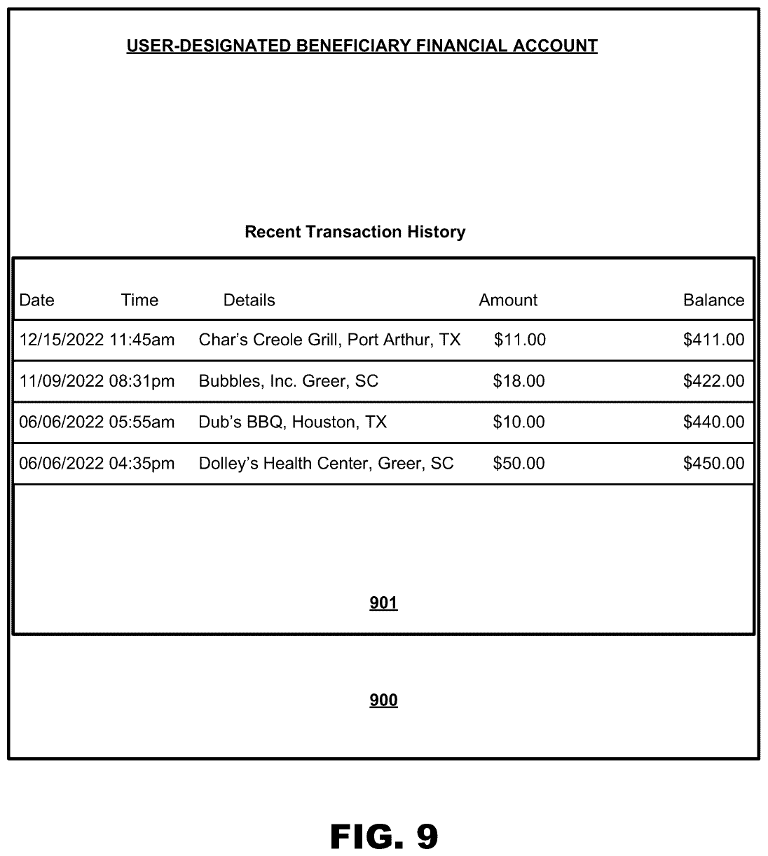

As illustrated in FIG. 9, the computer-executable program code may instruct the one or more processors 210 to cause, in response to the user engaging the link in the electronic alert 801, the display, generation, or rendering of a GUI comprising a dashboard 900 for visual display on the user interface 131a of the first client device 100a. The dashboard 900 comprises a tile 901 that includes the recent transaction history, including the detected and authorized financial transaction.

In further operation, the designated beneficiary may, via the second client device 100b, transmit a request to increase the predetermined maximum financial transaction threshold to a specified monetary amount.

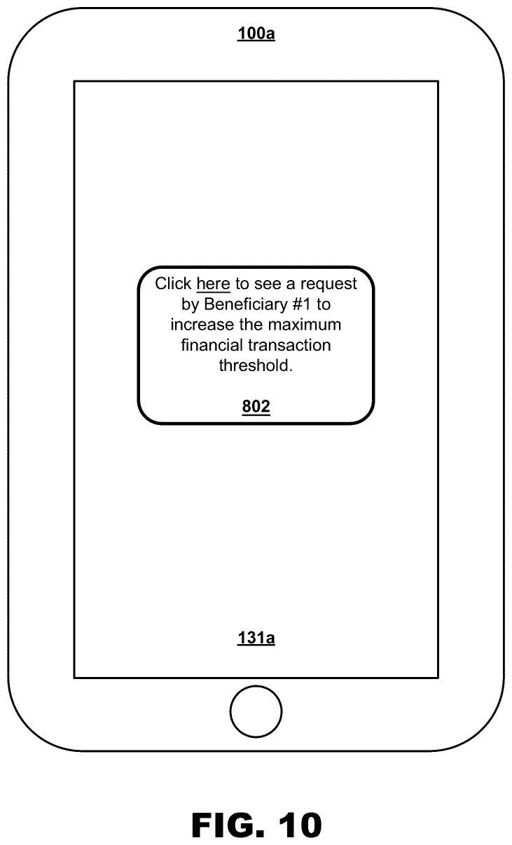

As illustrated in FIG. 10, the computer-executable program code may instruct the one or more processors 210 to transmit, in response to the request, an electronic alert 802 for visual display on the user interface 131a of the first client device 100a. The electronic alert 802 may comprise an email, text, pop-up, etc. that includes a user-engageable link.

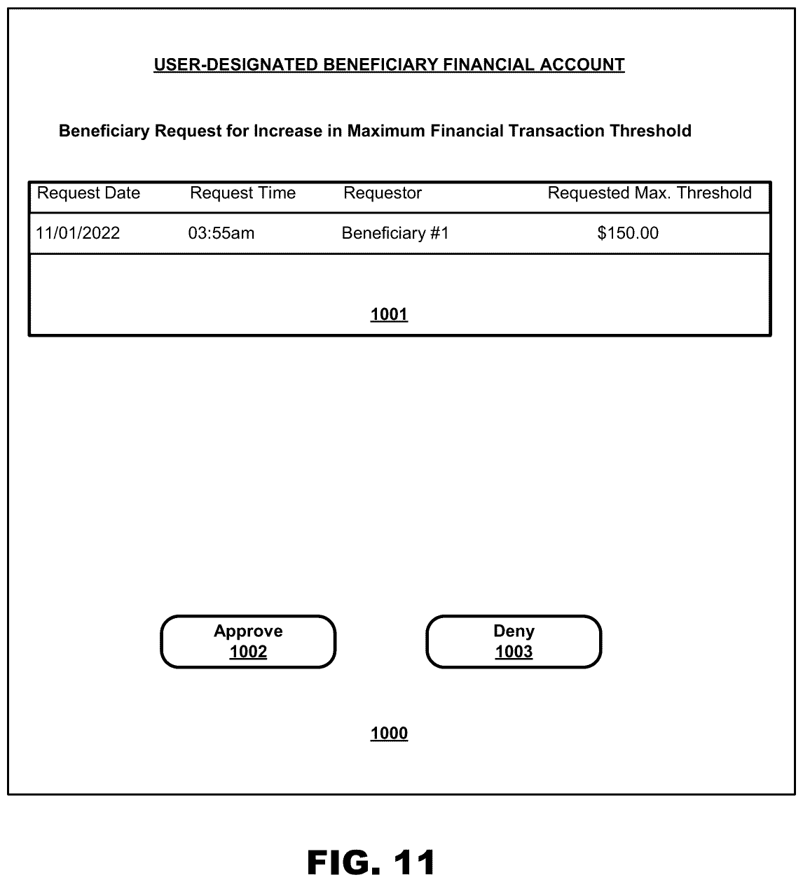

As illustrated in FIG. 11, the computer-executable program code may instruct the one or more processors 210 to cause, in response to the user engaging the link in the electronic alert 802, the display, generation, or rendering of a GUI comprising a dashboard 1000 for visual display on the user interface 131a of the first client device 100a. The dashboard 1000 comprises a tile 1001 that visually displays the information and data associated with the request, a first user-engageable icon 1002 to approve the request and a second user-engageable icon 1003 to deny the request.

The computer-executable program code may instruct the one or more processors 210 to increase, in response to receiving user approval of the request from the first client device 100a, the predetermined maximum financial transaction threshold to the specified monetary amount.

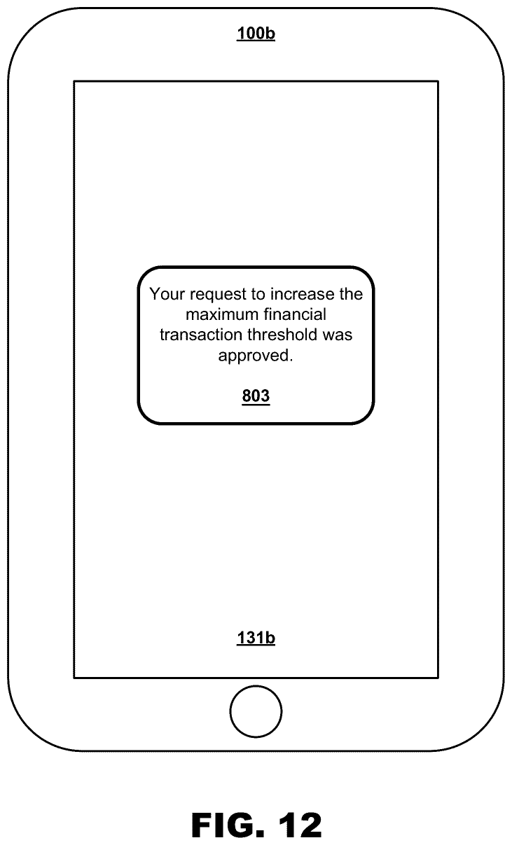

As illustrated in FIG. 12, the computer-executable program code may instruct the one or more processors 210 to transmit, in response to receiving user approval or user denial of the request from the first client device 100a, an electronic alert 803 for visual display on the user interface 131a of the first client device 100a. The electronic alert 801 may comprise an email, text, pop-up, etc. that indicates whether the request was approved or denied.

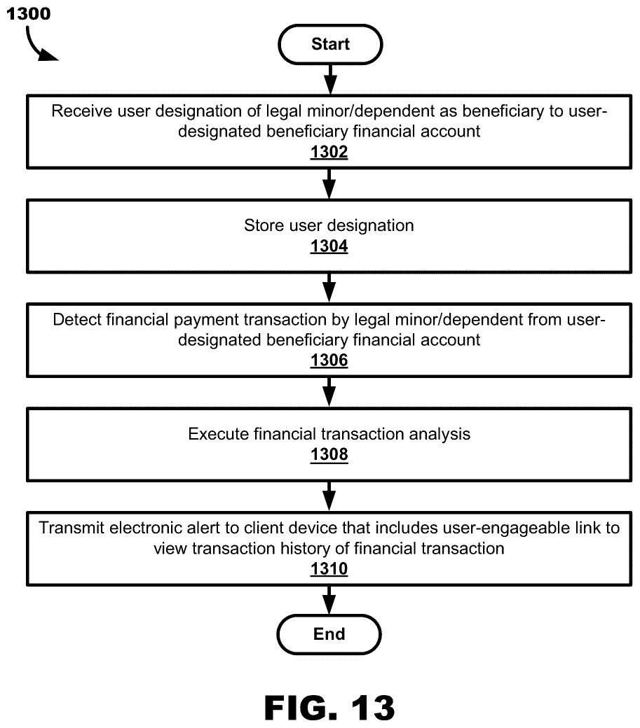

Illustrated examples shown in FIGS. 13 to 15 set forth computer-implemented methods 1300, 1400, and 1500. In one or more examples, the respective flowcharts of the computer-implemented methods 1300, 1400, and 1500 may be implemented by the one or more processors 210 of the one or more financial institution servers 200. In particular, the computer-implemented methods 1300, 1400, and 1500 may be implemented as one or more modules in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

In accordance with one or more embodiments set forth, described, and/or illustrated herein, software executed by the one or more financial institution servers 200 provides functionality described or illustrated herein. In particular, software executed by the one or more processors 210 is operable to perform one or more processing blocks of the computer-implemented methods 1300, 1400, and 1500 set forth, described, and/or illustrated herein, or provides functionality set forth, described, and/or illustrated.

As illustrated in FIG. 13, illustrated process block 1302 includes receiving, by one or more financial institution servers associated with a financial institution and from a client device of a user having one or more primary financial accounts at a financial institution, a designation of a legal minor/dependent as a beneficiary to a user-designated beneficiary financial account that is associated with the one or more primary financial accounts.

The computer-implemented method 1300 may then proceed to illustrated process block 1304, which includes storing, by the one or more financial institution servers, the designation in non-transitory memory of the one or more financial institution servers.

The computer-implemented method 1300 may then proceed to illustrated process block 1306, which includes detecting, by the one or more financial institution servers, a financial transaction having a monetary amount that is paid by the legal minor/dependent using a user-authorized financial payment instrument associated with the user-designated beneficiary financial account.

The computer-implemented method 1300 may then proceed to illustrated process block 1308, which includes executing, by the one or more financial institution servers in response to the detection, financial transaction analysis based on stored user account settings data associated with the user-designated beneficiary financial account.

In accordance with process block 1308, executing the financial transaction analysis comprises determining whether the monetary amount of the financial transaction is greater than a predetermined maximum financial transaction threshold that is stored in the non-transitory memory.

In accordance with process block 1308, executing the financial transaction analysis comprises conducting a comparison between the monetary amount and the predetermined maximum financial transaction threshold.

In accordance with process block 1308, executing the financial transaction analysis comprises determining whether the monetary amount of the financial transaction is less than a predetermined minimum financial transaction threshold that is stored in the non-transitory memory.

In accordance with process block 1308, executing the financial transaction analysis comprises conducting a comparison between the monetary amount and the predetermined minimum financial transaction threshold.

The computer-implemented method 1300 may then proceed to illustrated process block 1310, which includes transmitting, by the one or more financial institution servers in response to the execution, an electronic alert to the client device that includes a user-engageable link that, when engaged by the user, facilitates viewing of a transaction history of the financial transaction.

The computer-implemented method 1300 may terminate or end after execution of process block 1310.

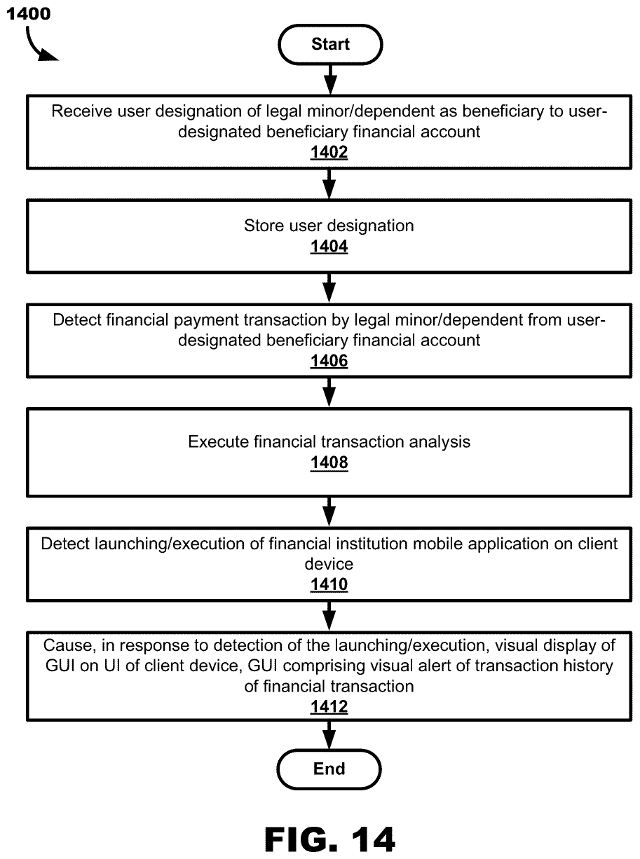

As illustrated in FIG. 14, illustrated process block 1402 includes receiving, by one or more financial institution servers associated with a financial institution and from a client device of a user having one or more primary financial accounts at a financial institution, a designation of a legal minor/dependent as a beneficiary to a user-designated beneficiary financial account that is associated with the one or more primary financial accounts.

The computer-implemented method 1400 may then proceed to illustrated process block 1404, which includes storing, by the one or more financial institution servers, the designation in non-transitory memory of the one or more financial institution servers.

The computer-implemented method 1400 may then proceed to illustrated process block 1406, which includes detecting, by the one or more financial institution servers, a financial transaction having a monetary amount that is paid by the legal minor/dependent using a user-authorized financial payment instrument associated with the user-designated beneficiary financial account.

The computer-implemented method 1400 may then proceed to illustrated process block 1408, which includes executing, by the one or more financial institution servers in response to the detection, financial transaction analysis based on stored user account settings data associated with the user-designated beneficiary financial account.

In accordance with process block 1408, executing the financial transaction analysis comprises determining whether the monetary amount of the financial transaction is greater than a predetermined maximum financial transaction threshold that is stored in the non-transitory memory.

In accordance with process block 1408, executing the financial transaction analysis comprises conducting a comparison between the monetary amount and the predetermined maximum financial transaction threshold.

In accordance with process block 1408, executing the financial transaction analysis comprises determining whether the monetary amount of the financial transaction is less than a predetermined minimum financial transaction threshold that is stored in the non-transitory memory.

In accordance with process block 1408, executing the financial transaction analysis comprises conducting a comparison between the monetary amount and the predetermined minimum financial transaction threshold.

The computer-implemented method 1400 may then proceed to illustrated process block 1410, which includes detecting, by the one or more financial institution servers in response to the detection of the financial transaction, execution of a software mobile application associated with the financial institution (“financial institution mobile application”) on the client device.

The computer-implemented method 1400 may then proceed to illustrated process block 1412, which includes causing, by the one or more financial institution servers in response to the detection of the execution of the financial institution mobile application, display of a graphical user interface (GUI) on a user interface of the client device, the GUI comprising a visual alert of the transaction history of the financial transaction.

The computer-implemented method 1400 may terminate or end after execution of process block 1412.

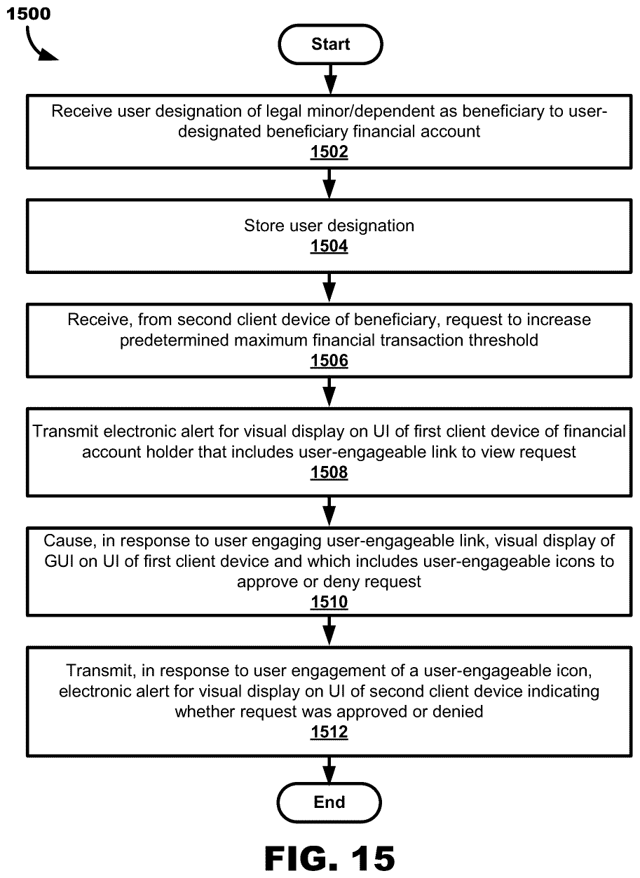

As illustrated in FIG. 15, illustrated process block 1502 includes receiving, by one or more financial institution servers associated with a financial institution and from a client device of a user having one or more primary financial accounts at a financial institution, a designation of a legal minor/dependent as a beneficiary to a user-designated beneficiary financial account that is associated with the one or more primary financial accounts.

The computer-implemented method 1500 may then proceed to illustrated process block 1504, which includes storing, by the one or more financial institution servers, the designation in non-transitory memory of the one or more financial institution servers.

The computer-implemented method 1500 may then proceed to illustrated process block 1506, which includes receiving, by the one or more financial institution servers from a second client device of the beneficiary, a request to increase a predetermined maximum financial transaction threshold to a specified monetary amount.

The computer-implemented method 1500 may then proceed to illustrated process block 1508, which includes transmitting, by the one or more financial institution servers in response to the request, an electronic alert for visual display on UI of the first client device, the electronic alert including a user-engageable link to view the request.

The computer-implemented method 1500 may then proceed to illustrated process block 1510, which includes causing, by the one or more financial institution servers in response to the user engaging the user-engageable link, a GUI for visual display on the UI of the first client device, the GUI including a first user-engageable icon to approve the request and a second user-engageable icon to deny the request.

The computer-implemented method 1500 may then proceed to illustrated process block 1512, which includes transmitting, by the one or more financial institution servers in response to the user engaging one of the user-engageable icons, an electronic alert (e.g., email, text, pop-up, etc.) to the second client device that includes an indication of whether the request was approved or denied.

In accordance with one or more embodiments set forth, described, and/or illustrated herein, the first client device 100a, the second client device 100b, and the one or more financial institution servers 200 could function in a fully virtualized environment. A virtual machine is where all hardware is virtual and operation is run over a virtual processor. The benefits of computer virtualization have been recognized as greatly increasing the computational efficiency and flexibility of a computing hardware platform. For example, computer virtualization facilitates multiple virtual computing machines to execute on a common computing hardware platform. Similar to a physical computing hardware platform, virtual computing machines include storage media, such as virtual hard disks, virtual processors, and other system components associated with a computing environment. For example, a virtual hard disk can store the operating system, data, and application files for a virtual machine. Virtualized computer system includes computing device or physical hardware platform, virtualization software running on hardware platform, and one or more virtual machines running on hardware platform by way of virtualization software. Virtualization software is therefore logically interposed between the physical hardware of hardware platform and guest system software running “in” virtual machine.

Memory of the hardware platform may store virtualization software and guest system software running in virtual machine. Virtualization software performs system resource management and virtual machine emulation. Virtual machine emulation may be performed by a virtual machine monitor (VMM) component. In typical implementations, each virtual machine (only one shown) has a corresponding VMM instance. Depending on implementation, virtualization software may be unhosted or hosted. Unhosted virtualization software generally relies on a specialized virtualization kernel for managing system resources, whereas hosted virtualization software relies on a commodity operating system: the “host operating system,” such as Windows or Linux to manage system resources. In a hosted virtualization system, the host operating system may be considered as part of virtualization software.

The system and method described herein may be at least partially processor-implemented, the one or more processors 210 being an example of hardware. For example, at least some of the operations of the computer-implemented methods may be performed by the one or more processors 210 or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors 210, not only residing within a single machine, but deployed across a plurality of machines. In some example embodiments, the one or more processors 210 or processor-implemented modules may be located in a single geographic location (e.g., within a home environment, an office environment, or a server farm). In other example embodiments, the one or more processors or processor-implemented modules may be distributed across a plurality of geographic locations.

Devices that are described as in “communication” with each other or “coupled” to each other need not be in continuous communication with each other or in direct physical contact, unless expressly specified otherwise. On the contrary, such devices need only transmit to each other as necessary or desirable, and may actually refrain from exchanging data most of the time. For example, a machine in communication with or coupled with another machine via the Internet may not transmit data to the other machine for long period of time (e.g. weeks at a time). In addition, devices that are in communication with or coupled with each other may communicate directly or indirectly through one or more intermediaries.

The terms “coupled,” “attached,” or “connected” may be used herein to refer to any type of relationship, direct or indirect, between the components in question, and may apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

Those skilled in the art will appreciate from the foregoing description that the broad techniques of the exemplary embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. An apparatus, comprising:
one or more processors; and
a non-transitory memory coupled to the one or more processors, the non-transitory memory including a set of instructions of computer-executable program code, which when executed by the one or more processors, cause the apparatus to:
receive, from a client device of a user executing a mobile application associated with a financial institution, a designation of a legal minor/dependent as a beneficiary to a user-designated beneficiary financial account that is associated with one or more primary financial accounts of the user at the financial institution;
detect a financial transaction having a monetary amount that is paid by the legal minor/dependent using a user-authorized financial payment instrument associated with the user-designated beneficiary financial account;
execute, in response to the detection, financial transaction analysis based on stored user account settings data associated with the user-designated beneficiary financial account; and
transmit, in response to the execution, an electronic alert to the client device that includes a user-engageable link that, when engaged by the user, facilitates viewing of a transaction history of the financial transaction.

2. The apparatus of claim 1, wherein the set of instructions, which when executed by the one or more processors, cause the apparatus to execute the financial transaction analysis by determining if the monetary amount of the financial transaction is greater than a predetermined maximum threshold.

3. The apparatus of claim 2, wherein the set of instructions, which when executed by the one or more processors, cause the apparatus to execute the financial transaction analysis by conducting a comparison between the monetary amount and the predetermined maximum threshold.

4. The apparatus of claim 1, wherein the set of instructions, which when executed by the one or more processors, cause the apparatus to execute the financial transaction analysis by determining if the monetary amount of the financial transaction is less than a predetermined minimum threshold.

5. The apparatus of claim 4, wherein the set of instructions, which when executed by the one or more processors, cause the apparatus to execute the financial transaction analysis by conducting a comparison between the monetary amount and the predetermined minimum threshold.

6. The apparatus of claim 1, wherein the set of instructions, which when executed by the one or more processors, cause the apparatus to detect, in response to the detection of the financial transaction, execution of a software mobile application associated with the financial institution on the client device.

7. The apparatus of claim 6, wherein the set of instructions, which when executed by the one or more processors, cause the apparatus to cause, in response to the detection of the execution of the mobile application, display of a graphical user interface (GUI) on a user interface of the client device, the GUI comprising a visual alert of the transaction history of the financial transaction.

8. A computer program product comprising at least one non-transitory computer readable medium having with a set of instructions of computer-executable program code, which when executed by one or more processors of a computing device, cause the computing device to:
receive, from a client device of a user executing a mobile application associated with a financial institution, a designation of a legal minor/dependent as a beneficiary to a user-designated beneficiary financial account that is associated with one or more primary financial accounts of the user at the financial institution;
detect a financial transaction having a monetary amount that is paid by the legal minor/dependent using a user-authorized financial payment instrument associated with the user-designated beneficiary financial account;
execute, in response to the detection, financial transaction analysis based on stored user account settings data associated with the user-designated beneficiary financial account; and
transmit, in response to the execution, an electronic alert to the client device that includes a user-engageable link that, when engaged by the user, facilitates viewing of a transaction history of the financial transaction.

9. The computer program product of claim 8, wherein the set of instructions, which when executed by the one or more processors, cause the computing device to execute the financial transaction analysis by determining if the monetary amount of the financial transaction is greater than a predetermined maximum threshold.

10. The computer program product of claim 9, wherein the set of instructions, which when executed by the one or more processors, cause the computing device to execute the financial transaction analysis by conducting a comparison between the monetary amount and the predetermined maximum threshold.

11. The computer program product of claim 8, wherein the set of instructions, which when executed by the one or more processors, cause the computing device to execute the financial transaction analysis by determining if the monetary amount of the financial transaction is less than a predetermined minimum threshold.

12. The computer program product of claim 11, wherein the set of instructions, which when executed by the one or more processors, cause the computing device to execute the financial transaction analysis by conducting a comparison between the monetary amount and the predetermined minimum threshold.

13. The computer program product of claim 8, wherein the set of instructions, which when executed by the one or more processors, cause the computing device to detect, in response to the detection of the financial transaction, execution of a software mobile application associated with the financial institution on the client device.

14. The computer program product of claim 8, wherein the set of instructions, which when executed by the one or more processors, cause the computing device to cause, in response to the detection of the execution of the mobile application, display of a graphical user interface (GUI) on a user interface of the client device, the GUI comprising a visual alert of the transaction history of the financial transaction.

15. A computer-implemented method, comprising:
receiving, by one or more financial institution servers associated with a financial institution from a client device of a user executing a mobile application associated with the financial institution, a designation of a legal minor/dependent as a beneficiary to a user-designated beneficiary financial account that is associated with one or more primary financial accounts of the user at the financial institution;
detecting, by the one or more financial institution servers, a financial transaction having a monetary amount that is paid by the legal minor/dependent using a user-authorized financial payment instrument associated with the user-designated beneficiary financial account;
executing, by the one or more financial institution servers in response to the detection, financial transaction analysis based on stored user account settings data associated with the user-designated beneficiary financial account; and
transmitting, by the one or more financial institution servers in response to the execution, an electronic alert to the client device that includes a user-engageable link that, when engaged by the user, facilitates viewing of a transaction history of the financial transaction.

16. The computer-implemented method of claim 15, further comprising, by the one or more financial institution servers, executing the financial transaction analysis by determining if the monetary amount of the financial transaction is greater than a predetermined maximum threshold.

17. The computer-implemented method of claim 16, further comprising, by the one or more financial institution servers, executing the financial transaction analysis by conducting a comparison between the monetary amount and the predetermined maximum threshold.

18. The computer-implemented method of claim 15, further comprising, by the one or more financial institution servers, executing the financial transaction analysis by determining if the monetary amount of the financial transaction is less than a predetermined minimum threshold.

19. The computer-implemented method of claim 18, further comprising, by the one or more financial institution servers, executing the financial transaction analysis by conducting a comparison between the monetary amount and the predetermined minimum threshold.

20. The computer-implemented method of claim 15, further comprising, by the one or more financial institution servers:
detecting, in response to the detection of the financial transaction, execution of a software mobile application associated with the financial institution on the client device; and
causing, in response to the detection the detection of the execution of the mobile application, display of a graphical user interface (GUI) on a user interface of the client device, the GUI comprising a visual alert of the transaction history of the financial transaction.
